(19) United States
(12) Patent Application Publication
(10) Pub. No.: US 2018/0260756 A1
(43) Pub. Date: Sep. 13, 2018

(54) AGENT BASED OUTCOME PREDICTION METHODS AND SYSTEMS

(71) Applicant: SENTURION FORECASTING, LLC, New York, NY (US)

(72) Inventors: Mark Abdollahian, Altadena, CA (US); Carole Alsharabati, Beirut (LB); Jacek Kugler, Claremont, CA (US)

(21) Appl. No.: 15/717,806

(22) Filed: Sep. 27, 2017

Related U.S. Application Data
(63) Continuation of application No. 15/433,992, filed on Feb. 15, 2017, now abandoned.
Application No. 15/433,992 is a continuation of application No. 11/778,616, filed on Jul. 16, 2007, now abandoned.
Application No. 11/778,616 is a continuation of application No. 11/602,545, filed on Nov. 20, 2006, now abandoned.
Application No. 11/602,545 is a continuation of application No. 11/378,207, filed on Mar. 13, 2006, now abandoned.
Application No. 11/378,207 is a continuation of application No. 11/212,034, filed on Aug. 24, 2005, now abandoned.
(60) Provisional application No. 60/604,423, filed on Aug. 24, 2004.

(51) Int. Cl. G06Q 10/06; G06Q 10/04

(52) U.S. Cl. CPC G06Q 10/06375; G06Q 10/04; G06Q 10/0635

(57) ABSTRACT

An agent-based modeling system and method including the use of risk values based on distance from a median position. Per agent withdrawals are supported based on changes in position and considering risk aversion. Multiple issue methods are provided, in some embodiments by determining an effective median position based on maximization of utility related values.

### CROSS-REFERENCE TO RELATED APPLICATION

This application claims the benefit of the filing date of U.S. Provisional Patent Application No. 60/604,423, filed Aug. 24, 2005, the disclosure of which is incorporated herein.

### BACKGROUND OF THE INVENTION

The present invention relates generally to outcome predictive methods and systems, and more particularly to agent-based outcome modeling.

Evaluating options and predicting outcomes of real-world interactions and negotiations occurs in a variety of settings, ranging from mundane consumer purchases to governmental strategic arenas. In some instances evaluation and prediction is a simple matter, often involving few parties, a single issue, and significant accurate information about the parties, how the parties view the issue, and the parties positions regarding the issue. In other circumstances evaluation and prediction is a difficult and uncertain task. Many parties may be involved and the parties may have fractured views regarding the situation. The number of issues may be large and possibly interrelated. The possible actions, and iterations of actions, may encompass vast possibilities. Consideration of potential outcomes in such situations may not only be difficult, but effectively impossible to perform in a timely manner through mental analysis alone.

The use of analytical tools, such as those employing numerical methods executed by electronic processing devices, may allow for increased insight into complicated problems. The complicated problems may relate, for example, to issues faced by businesses in performing negotiations related to contractual or litigation issues. Such tools may model actors as rational beings attempting to maximize utility to themselves, taking into account the actors current position, their views on utility, the importance they place on particular issues, and their willingness to accept risk. Economists and others have studied quantitative methods to attempt to provide insight into past outcomes and future events, and these quantitative methods may be useful in implementing computerized numerical methods predicting behaviors and potential outcomes.

The value such negotiation or political forecasting tools may provide is, of course, dependent on many factors, including the accuracy of results provided by the tools and the ability of the tools to provide those results in a timely manner. The particular numerical methods used, as implemented through for example processor configuration, may provide different results, with differing levels of accuracy. Moreover, in some instances there may not be clarity as to what numerical methods to use, or how to obtain results when multiple potentially valid results are present.

### SUMMARY OF THE INVENTION

An agent-based predictive model for use in negotiations and scenario analysis. In one aspect the invention provides an assessment of the likely outcome of a negotiation or political scenario and second, allows the exploration of alternative tactics and strategies to change that negotiation or political scenario to be more in favor of what is desired. In one aspect the invention provides in a multiple issue agent-based outcome prediction method executed by a computer which considers risk aversion of a stakeholder, the prediction method including determining changes in stakeholder positions based on positions of stakeholders and expected utilities of changes in position, a process for determining a risk aversion of the stakeholder, comprising determining a center of gravity of an n-dimensional space; determining a distance between a position of the stakeholder in the n-dimensional space and the center of gravity; and determining a risk value indicative of risk aversion of the stakeholder based on the distance between the position of the stakeholder and the center of gravity.

These and other aspects of the invention are more fully comprehended upon review of this disclosure, including the accompanying figures.

### BRIEF DESCRIPTION OF THE FIGURES

FIG. 1 is a flow diagram of a process for determining outcomes using agent-based techniques in accordance with aspects of the invention;

FIG. 2 is a block diagram of a computer with a processor configurable for use in accordance with aspects of the invention;

FIG. 3 is a is a flow diagram of a process for executing a round in accordance with aspects of the invention;

FIG. 4 is a chart useful in considering expected utilities in accordance with aspects of the invention;

FIG. 5 is a flow diagram of a process for determining a risk value in accordance with aspects of the invention; and

FIG. 6 is a chart showing a multi-dimensional issue space in accordance with aspects of the invention.

### DETAILED DESCRIPTION

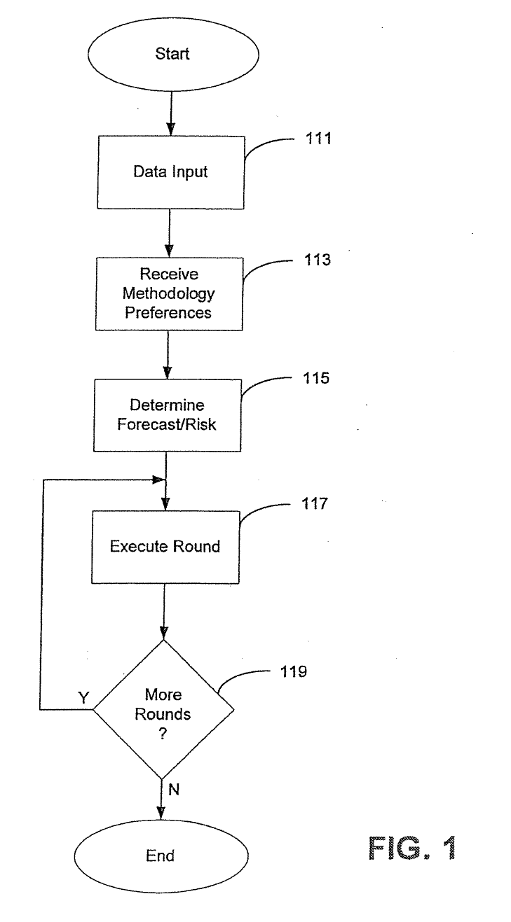

FIG. 1 is a flow diagram of a top level process in accordance with aspects of the invention. In block 111 data regarding stakeholders is received. Stakeholders are parties, whether identified as individuals or groups, with an interest in an outcome of a matter or the ability to affect the outcome of a matter. The data regarding the stakeholders includes, in various embodiments, an identifier for the stakeholder, a preferred position of the stakeholder regarding possibly a plurality of issues, the importance each stakeholder attaches to each issue, and the influence each stakeholder has with respect to each issue.

In block 113 methodology preferences are received. The methodology preferences may include, in various embodiments, a selected statistical methodology and a selected stepping function. The selected stepping function may be, for example, a bargaining stepping function, a position stepping function, or an importance stepping function.

In block 115 stakeholder context related information is determined. In some embodiments the stakeholder context information comprises information regarding the risk propensity of the stakeholder, determined using the position of the stakeholder compared to the positions of the other stakeholders, in some embodiments a median position of the stakeholders.

In block 117 a round is executed. In various embodiments executing a round includes determining a relationship between expected utilities of pairs of stakeholders, generally considering expected utilities as viewed by both stakeholders of a pair, determining potential offers for each stakeholder, and determining a change in position for each stakeholder. In some embodiments a round further includes determining missed opportunities, generally by considering different views of expected utility as viewed by different stakeholders. Determining missed opportunities may include iteratively determining missed opportunities for each stakeholder and re-determining potential offers for each stakeholder and a change in position for each stakeholder.

In some embodiments executing a round additionally includes determining whether a stakeholder ceases making potential offers.

In block 119 the process determines if further rounds should be executed. If yes, then the process returns to block 115. If no, then the process provides a result and then exits. In most embodiments returning a result comprises providing an end position for each stakeholder.

In some embodiments the process is performed using a user computer, which may be linked to a number of computers. In some embodiments, the user computer comprises a personal computer (PC), and includes, for example, a processor and various input/output devices. In alternative embodiments, however, the user computer comprises an engineering work station, such as a SPARC machine for other systems supporting web based communications and display functions. In other embodiments the process is performed using a client-server architecture, with a first computer, such as described above or some other digital device, communicating with a second computer which performs the process.

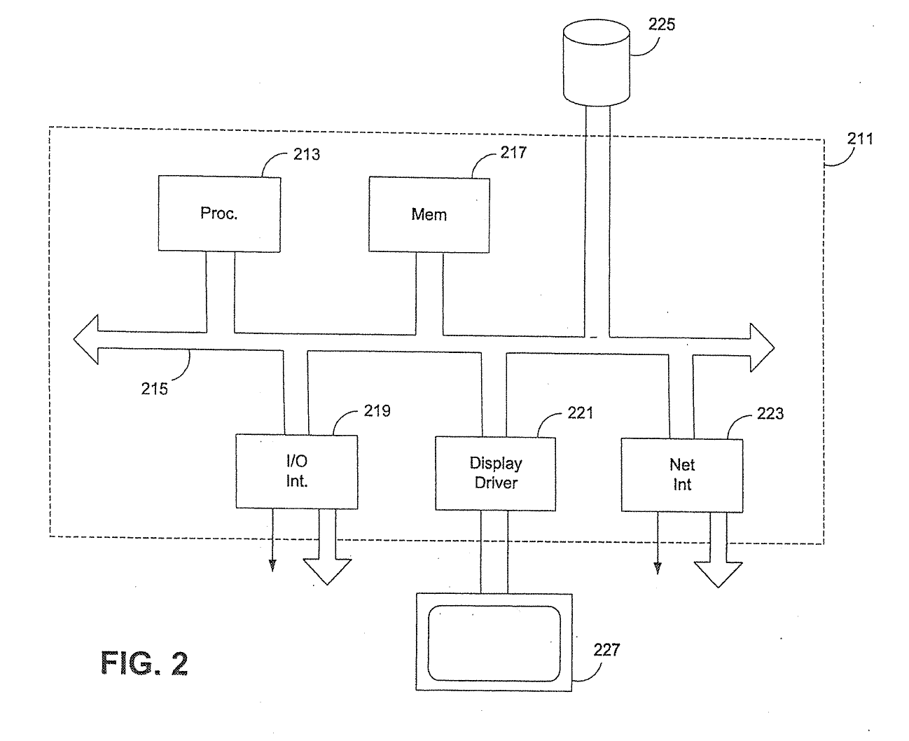

In various embodiments, the user computer, the first computer, or the second computer is a computer having a processor, memory, mass memory storage, network interface cards, and associated items, and in some embodiments operates under a UNIX-based operating system. FIG. 2 is a block diagram of a computer 211 and some associated elements used in some embodiments of the invention. The computer includes a processor 213. The processor is configured, generally by way of software instructions, to execute processes in accordance with the invention. The processor is coupled to a bus 215. The bus couples elements of the computer, providing for passing of information between elements of the computer. A memory 217 is coupled to the processor by way of the bus, with the memory providing for example temporary storage of information used by the processor or other elements. The computer also includes I/O interface elements 219, display driver 221, and network interface devices 223. Coupled to the computer, and in some aspects considered part of the computer, are memory device 225 and display device 227.

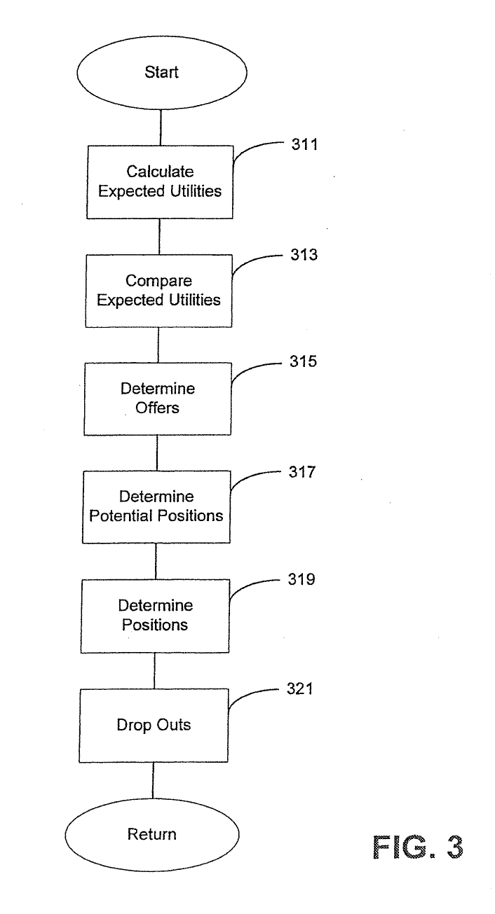

FIG. 3 is a flow chart providing some additional detail regarding execution of a round. In block 311 for each pair of stakeholders expected utilities to challenging the position of others is determined, for use in some embodiments in solving a general full information game theoretic tree. In general, the expected utility is calculated by determining the expected utility of making an offer discounted by the expected utility of not making an offer. The expected utility of making an offer often includes the probability of gain made by making an offer, considering gains made if the offer is accepted and if the offer is not accepted, weighted by the importance a stakeholder places on the issue.

In some embodiments the expected utilities are determined, with scaling factors included in some of the equations, by considering an expected utility of a challenge

Sⱼ×[Pᵢ×(winᵢⱼⁱ)+(1−Pᵢ)×(loseᵢⱼⁱ)]+(1−Sⱼ)[(winᵢⱼⁱ)],

where

$${win}_{ij}^{i} = 2 - ( 4 * \frac{( 2 - 2 * \vert {pos}_{i} - {pos}_{j} \vert )}{4} ⋀ {R}_{i} )$$

$${lose}_{ij}^{i} = 2 - ( 4 * \frac{( 2 + 2 * \vert {pos}_{i} - {pos}_{j} \vert )}{4} ⋀ {R}_{i} ) ,$$

(with pos indicating a position of an indicated stakeholder and Rᵢ risk aversion/acceptance of the indicated stakeholder) and an expected utility of not challenging

{2−(4*0.5\hat{0}Rᵢ)−{2−4*[(2+2*|posᵢ−pos_{fore}|−2*|posᵢ−posⱼ|)/4]^{Ri}}}/2

with pos_{fore} indicating a forecast position. In some embodiments the expected utility of not challenging may be viewed as a sum of a value of the status quo, modified by risk value, and a value of change.

In some embodiments P may be considered a level of influence of a stakeholder plus the influence of other stakeholders who would support the stakeholder, for example those close to the position of the stakeholder. In some embodiments Pᵢ is determined by considering positions, influence, and importance of stakeholders, for example by determining all

$$Vjk = {\sum }_{i = 1}^{n} [ {resources}_{i} \times {salience}_{i} ( - 2 * \vert {position}_{i} - {position}_{j} \vert + 2 * \vert {position}_{i} - {position}_{k} \vert ) ] * convRisk$$

with ConvRisk=exp{R*(−2*|positionᵢ−positionⱼ|+2*|positionᵢ−positionₖ|)}
and calculating
   Sum of all Vjk for which i is closer to j then to k=VjkClose
   Sum of all Vjk=VjkTot

Finally:

P=(VjkClose+Resourceⱼ*Salienceⱼ)/(VjkTot+Resourceⱼ*Salienceⱼ+Resourceₖ*Salienceₖ),

In the above equations, scaling facters are used, but may be modified when different scaling, such as for positions, is used. Further information may be found in Bueno de Mesquita and Lalman “Reason and War” APSR 1986 p. 1119-1121 and Bueno de Mesquite, “A Decision Making Model: Its Structure and Form”, International Interactions 1997, p. 235-266, both of which are incorporated by reference herein. In addition, in the equations, the absolute value of the difference in positions is in some embodiments, particularly multiple issue embodiments, a distance between positions.

Preferably, the gains are also weighted exponentially by the risk factor, with increased risk-aversion serving to amplify the gains. Such a result possibly reflects that those who are risk-averse are more satisfied with smaller gains.

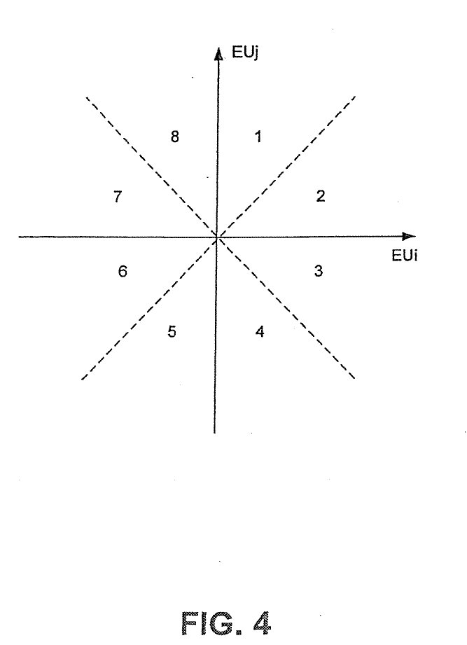

In block 313 , in some embodiments, the expected utilities for each pair of stakeholders are considered in relation to one another. Using an example of a single issue, the expected utilities may be considered graphically as shown in FIG. 4. In FIG. 4 the expected utility of a first stakeholder i is represented by an x-axis and the expected utility of a second stakeholder j is represented by the y-axis. The x-y plane may be divided into octants separated by lines including the origin, separated by forty-five degrees, and including the x-axis and the y-axis. The octants serve to generally delineate whether changes in expected utility for one stakeholder are expected to be greater than changes in expected utility for the other stakeholder, with the quadrant of the octant indicating gains or losses in expected utility for each stakeholder. The use of octants is convenient in that they serve to separate quadrants, while also indicating a ratio in expected utilities between stakeholder i and stakeholder j.

The octants also may be numbered, for descriptive purposes, in a clockwise manner from the y-axis. Thus, the expected utilities may located in a specific identified octant. As indicated in the table below, each octant reflects a region defined by whether the expected utilities of each of stakeholders i and j is positive or negative, and whether the ratio of expected utilities is greater for stakeholder i or stakeholder j.

| octant | description |
|---|---|
| 1 | EUi > 0, EUj > 0, \|EUj\|/\|EUi\| > 1 |
| 2 | EUi > 0, EUj > 0, \|EUi\|/\|EUj\| > 1 |
| 3 | EUi > 0, EUj < 0, \|EUi\|/\|EUj\| > 1 |
| 4 | EUi > 0, EUj < 0, \|EUj\|/\|EUi\| > 1 |
| 5 | EUi < 0, EUj < 0, \|EUj\|/\|EUi\| > 1 |
| 6 | EUi < 0, EUj < 0, \|EUi\|/\|EUj\| > 1 |
| 7 | EUi < 0, EUj > 0, \|EUi\|/\|EUj\| > 1 |
| 8 | EUi < 0, EUj > 0, \|EUj\|/\|EUi\| > 1 |

In block 315 offers by stakeholders are determined. In general, stakeholders make offers dependent on the octant in which the expected utilities are located.

In block 317 potential new positions by each stakeholder are determined. The potential new positions are based on expected responses to each offer. In general the potential new positions are dependent on the octant in which the expected utilities are located. Depending on the octant, or more generally speaking the ratio of changes in expected utility and whether expected utility is increasing or decreasing for each stakeholder, the potential new position may be no potential new position, a potential new position towards the offer by a proportion based on the ratio of expected utilities, or a potential new position accepting the offer.

A variety of methods are known by those in the art for determining offers and resultant new positions when considering expected utilities of presented offers. In one embodiment no accepted offers are made when either the expected utilities of making offers for both stakeholder i and stakeholder j are positive or both magnitudes of expected utility of making offers for both stakeholder i and stakeholder j are negative. For example, if the expected utilities for both stakeholders in making an offer is positive then the stakeholders may be viewed as in conflict that is not necessarily resolvable. The expected utility in making an offer for both stakeholders is negative, then it is likely that neither will make an offer as the status quo is preferable. When considering the chart of FIG. 4, therefore, in some embodiments if the expected utilities map to octants 1, 2, 5, or 6, then no offer is made.

In such an embodiment offers are made if the expected utility of making an offer is positive for one stakeholder and negative for the other stakeholder. For example, the expected utility of i making an offer is positive for i and expected utility of j making an offer is negative for j, then i will make an offer. A potential move based on the offer is dependent on whether the ratio of EUi/EUj is greater than the ratio of EUj/EUi. If the magnitude of the increase in expected utility for stakeholder i is greater than the magnitude of decrease of expected utility for stakeholder j then j will be considered to have a potential new position towards the position of stakeholder i. In many embodiments the potential new position is a proportional move towards position i based on the ratio of EUi/EUj.

In block 319 new positions are determined for each stakeholder. In many embodiments the new position for each stakeholder is the potential new position least distant from the current position of the stakeholder. The new position may therefore be considered the potential new position closest to the current position. In some embodiments, however, the new position is the potential new position closest to the initial position of the stakeholder, if the stakeholder is risk acceptant. Moreover, in some embodiments the new position is the potential new position closest a weighted average of the current position and the initial position, with the weighting based on the risk aversion of the stakeholder and the initial position being more strongly weighted as the stakeholder is more risk acceptant.

In block 321 stakeholder withdrawal from negotiations is considered. In some embodiments whether a stakeholder withdraws from negotiations, or drops out of the bargaining process, is determined by considering the change in forecasted position of the current round in view of the forecasted position of the previous round. If the difference considering the risk-aversion of the stakeholder is small then the stakeholder no longer participates in the bargaining process. In some embodiments the extent the stakeholder is risk averse serves to exponentially amplify the difference in forecasted position.

Thus, in some embodiments individual stakeholders may withdraw from negotiations while other stakeholders continue to negotiate in further iterations of rounds. Individual stakeholders who are risk acceptant are more likely to discount the value of continued negotiations, and withdraw from negotiations in the absence of significant progress towards their positions. Risk averse stakeholders, however, such as those near a median position or a forecast, are more likely to continue negotiations.

In some embodiments, for each stakeholder the following is determined:

exit=(forecast,_{rndn}−forecast_{rndn-1})^{Risk}which may be normalized as

exit=2−4*((2−2*(forecast_{rndn}−forecast_{rndn-1}))/4)^{Risk}

with forecast_{rndn}, equal to a forecast calculated using current round positions, forecast_{rndn-1} equal to a forecast calculated using prior round positions, and an exit value below a predefined value indicating the stakeholder withdraws from negotiation.

The process thereafter returns.

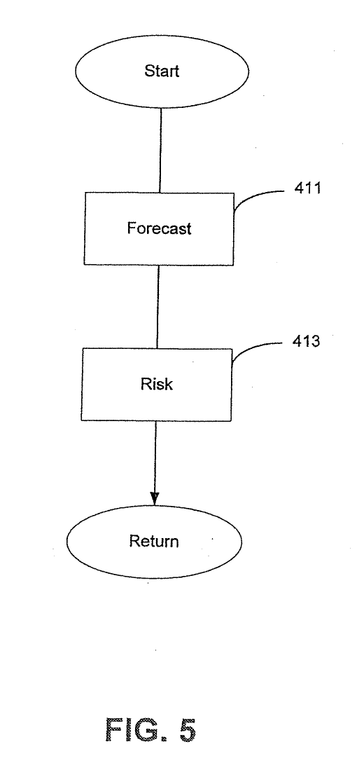

As discussed above, expected utilities are amplified, exponentially in many embodiments, by a risk value. FIG. 5 is a flowchart of a process of determining a risk value. In block 511 a forecast is made. Preferably the forecast is the median position of all the stakeholders, weighting the position of stakeholders by the influence each has with respect to the issue and the importance each attaches to the issue. In some embodiments the forecast is made by repeatedly selecting pairs of stakeholders, and determining which of the pair of stakeholders has a position closer to more of the other stakeholder positions, preferably weighting positions by the influence and importance of each stakeholder. After comparing each possible pair of stakeholders, a median position is determined to be the position of the stakeholder that has the closer position in the most pair-wise comparisons. In some embodiments the forecast is the position of the stakeholder that beats every other stakeholder in a pair-wise competition for votes.

In effect, in many embodiments, the forecast determines which stakeholder is closest to the median position of all of the stakeholders. In some embodiments the distance between stakeholders is weighted by the influence and importance of the stakeholder and each other stakeholder, with decreasing importance and decreasing power resulting in decreased distance. The position of the stakeholder closest to the median position is selected as the forecast.

In some embodiments the forecast is determined as follows. For every pair of stakeholders j and k calculate

$$Vjk = {\sum }_{i = 1}^{n} [ {resources}_{i} \times {salience}_{i} ( \vert {position}_{i} - {position}_{j} \vert - \vert {position}_{i} - {position}_{k} \vert ) ]$$

and incrementing a counter for stakeholder j if Vjk is negative and incrementing a counter for stakeholder k if Vjk is positive. The forecast is, in some embodiments, the position of the stakeholder with the highest counter.

In block 513 a risk value is assigned to each stakeholder. The risk value indicates the extent to which a stakeholder is risk-averse or risk-acceptant. In some embodiments the risk value is determined based on the distance between the stakeholder's current position and the forecast. For example, in some embodiments, the risk value indicates greater acceptance of risk with increasing distance between the stakeholder's current position and the forecast.

In some embodiments the risk value is determined as follows. For every stakeholder j calculate

$$Vj = {\sum }_{i = 1}^{n} {\sum }_{i = 1}^{n} [ {resources}_{i} \times {salience}_{i} ( - 2 * \vert {position}_{i} - {position}_{j} \vert + 2 * \vert {position}_{i} - {position}_{k} \vert ) ]$$

and then determine

$$Risk = - 1 * \frac{( Vj - VjMax ) + ( Vj - VjMin )}{VjMax - VjMin}$$

with VjMax equal to the forecast and Vjmin equal to a possible position with the greatest distance to the forecast. In many embodiments the risk value is transformed, by for example multiplication by (1−Risk/3)/(1+Risk/3) such that the risk value is in the range 0.5 to 2.0 for mathematical conveniency and then transformed to a −1, 0, +1 continuum, with +1 reflecting the most possible acceptance of risk and −1 reflecting the most possible aversion to risk.

In some embodiments multiple issues are considered simultaneously. Assuming the issues are, for example, orthogonal, positions of stakeholders may be considered as positions in an n-dimensional issue space. A forecast position, in some such embodiments the forecast may be considered as a location in the n-dimensional space forming what may be termed a center of gravity of the positions of the stakeholders in the n-dimensional space, preferably weighted by the power each stakeholder has with respect to each issue. Risk values for stakeholders may then be determined, in some embodiments, by distance to the center of gravity, with increasing distance to the center of gravity, preferably with distance weighted by power of all of the stakeholders, indicating greater risk acceptance.

In one embodiment center of gravity is determined as the location where the sum of utilities for all stakeholders is maximized, subject to the constraint that the utility for each stakeholder does not decrease. In some aspects the utilities are also weighted by the power each stakeholder has with respect to each issue, although in some embodiments the weighting is performed with respect to the importance, or salience, each stakeholder has with respect to each issue. For example, in one embodiment the process determines the maximum of

f=P₁U₁+P₂U₂+P₃U₃+ . . . +PₙUₙ

subject to

U₁>=U_{sq1}; U₂>=U_{sq2}; . . . Uₙ>=U_{sqn}

The utility for each stakeholder in such an embodiment may be considered as the negative of the distance between the status quo and the preferred position of the stakeholder, weighted by power in the equations above, or importance in some embodiments.

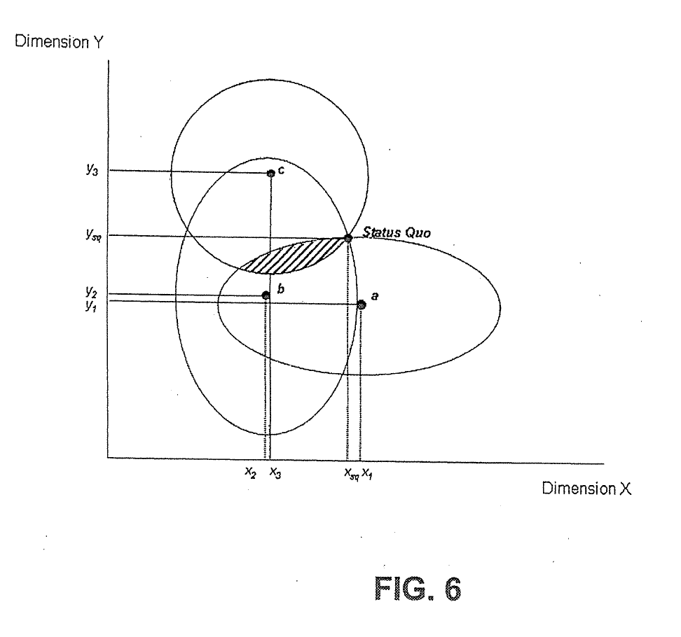

For example, in FIG. 6 three stakeholders which may be considered as stakeholder A, stakeholder B, and stakeholder C, are located on a two-dimensional space with two issues, X and Y. Stakeholders A, B and C have ideal points positioned at a (x₁, y₁), b (x₂, y₂) and c (x₃, y₃) respectively. The status quo is located at SQ (x_{sq}, y_{sq}). The utilities are a negative function of distance weighted by salience. In FIG. 6 relative saliences are indicated by closed surfaces centered on points a, b, and c. The shape of the closed surfaces indicate the relative salience, or importance stakeholders A, B, C place on issues X and Y. Stakeholder A has a higher salience on issue Y than X, stakeholder B has a higher salience on issue X than Y and Stakeholder C has equal salience on both issues.

Stakeholder A's utility for the status quo may be considered as:

U_{sq1}=−\sqrt{[Sₓ₁(x₁−x_{sq})²+S_{y1}(y₁−y_{sq})²]} (1)

With Sₓ₁ the salience of stakeholder A on issue X and S_{y3} the salience of stakeholder A as issue Y. The utility is considered as a negative function, with the maximum utility being zero when the status quo is located at stakeholder A's ideal position, or simply position, (X₁, Y₁). Stakeholder A's utility decreases as the status quo increases in distance, considering weighting provided by from stakeholder A's ideal position.

In some embodiments the center of gravity is considered as a location where the product of utility gain for each stakeholder is maximized, also with some aspects weighting the utilities by the power by the power each stakeholder has with respect to each issue. For example, in some embodiments the process determines the maximum of

f=(U₁−U_{sq1})*(U₂−U_{sq2})* . . . *(Uₙ−U_{sqn})

subject to

Uᵢ>=U_{sq1}; U₂>=U_{sq2}; . . . Uₙ>=U_{sqn}

Such a solution may be viewed as the Nash cooperative solution. In some embodiments the minimum proportion of potential is maximized.

In some embodiments the center of gravity is considered as the location where a minimum proportion of potential is maximized. The proportion of potential may be considered as the ratio of excess over potential, where for every stakeholder the excess is the increase in utility with respect to the status quo and potential is the difference between desired position and the status quo.

Expected utilities as discussed above are calculated using magnitudes of differences in positions of stakeholders. Such magnitudes, weighted by for example importances, may represent distances between positions of stakeholders. In multi-issue calculations use of distances, or magnitude of vectors, between stakeholders similarly may be used for expected utility calculations, summed over all of the issues. Similarly potential new positions may be calculated as movement along segments or vectors connecting positions of pairs of stakeholders.

Although the invention has been described with respect to certain specific embodiments, it should be recognized that the invention may be practiced other than as specifically described. Accordingly, the invention should be viewed as the claims and their equivalents supported by this disclosure.

1. In a multiple issue agent-based outcome prediction method executed by a computer which considers risk aversion of a stakeholder, the prediction method including determining changes in stakeholder positions based on positions of stakeholders and expected utilities of changes in position, a process for determining a risk aversion of the stakeholder, comprising:
determining a center of gravity of an n-dimensional space;
determining a distance between a position of the stakeholder in the n-dimensional space and the center of gravity; and
determining a risk value indicative of risk aversion of the stakeholder based on the distance between the position of the stakeholder and the center of gravity.

2. The method of claim 1 wherein each dimension of the n-dimensional space represent one of n issues and the center of gravity is determined by positions of m stakeholders with respect to n issues, with the positions of the m stakeholders weighted with respect to each of the n-dimensions by an importance each stakeholder places on each of corresponding n issues.

3. The method of claim 2 wherein n is greater than one.

4. The method of claim 3 wherein the center of gravity represents a point of maximization of utility for the m stakeholders.

5. The method of claim 3 wherein the center of gravity represents a point of maximization of increase in utility when compared to an initial point for the m stakeholders.

6. The method of claim 4 wherein the center of gravity represents a point of maximization of minimum proportion of potential for the m stakeholders.

7. The method of claim 1 further comprising determining if the stakeholder withdraws from negotiations based on risk aversion of the stakeholder.

8. The method of claim 7 wherein determining if the stakeholder withdraws from negotiation is further based on changes in center of gravity.

9. The method of claim 1 further comprising selecting a new position for the stakeholder by determining a new potential position of the stakeholder closest to an weighted average of a current position of the stakeholder and an initial position of the stakeholder, the weighted average using risk aversion as a weighing factor.
